(19) United States
(12) Patent Application Publication
(10) Pub. No.: US 2019/0154794 A1
(43) Pub. Date: May 23, 2019

(54) WAVEGUIDE ARRANGEMENT

(71) Applicant: IMEC vzw, Leuven (BE)

(72) Inventor: Ilja Ocket, Kessel-Lo (BE)

(21) Appl. No.: 16/195,772

(22) Filed: Nov. 19, 2018

Related U.S. Application Data
(63) Continuation of application No. PCT/EP16/61452, filed on May 20, 2016.

(51) Int. Cl. G01S 7/03; G01S 13/00; G01S 13/93; H01P 3/16; H01Q 1/32

(52) U.S. Cl. CPC G01S 7/032; G01S 13/003; H01Q 1/3233; H01P 3/16; H01P 3/165; G01S 13/931

(57) ABSTRACT

The disclosed technology relates to a waveguide arrangement for coupling a plurality of modules to a source. In one aspect, the waveguide arrangement comprises a continuous waveguide configured to guide a signal provided by the source and a plurality of interfaces, each interface being associated with one of the plurality of modules and being configured to transfer a part of the source signal guided in the waveguide to its associated module. The continuous waveguide allows the source signal to propagate continuously without needing reconversion at each module. As such, the waveguide arrangement loses less power and is more efficient. Moreover, each module receives the exact same input signal which improves the coherence between the modules.

### CROSS-REFERENCE TO RELATED APPLICATIONS

This application is a continuation of International Patent Application PCT/EP16/061452, filed on May 20, 2016, entitled “A WAVEGUIDE ARRANGEMENT,” which is incorporated herein by reference in its entirety.

### BACKGROUND

### Technological Field

The disclosed technology relates to a waveguide arrangement, particularly a waveguide arrangement for coupling a plurality of modules to a source.

### Description of the Related Technology

Multi-static radar systems combine different monostatic or bi-static radar subsystems to extract richer information about objects present in a surveyed scene. If the signals used by the different subsystems have a correlated phase noise, i.e. they are coherent, additional performance enhancement can be achieved, because all the transmitters and receivers act like one large multiple input multiple output (MIMO) radar system, i.e. a multi-static radar system having both multiple transmitter modules and multiple receiver modules. To achieve this coherence between the reference signals used by each subsystem, the output of the local oscillator used by the subsystems needs to be distributed over all of them. This is done by using a source which generates the local oscillator signal and a waveguide to distribute the source signal to the different subsystems.

In terms of performance, i.e. the decibel loss per metre, a traditional rectangular metal waveguide is the best option for frequencies in the lower millimetre wave range. However, a rectangular metal waveguide is bulky and difficult to integrate with a set of packaged systems-on-chip (SOCs). Lower weight metal waveguides, e.g. a foil placed around a dielectric core, have been demonstrated, but are still relatively expensive. On the other hand, thin flexible printed circuit boards (PCBs) are lightweight and easily integrated with packaged SOCs, but use planar transmission lines which tend to have a relatively high loss, especially at millimetre wave frequencies, i.e. the frequency range of the local oscillator.

In the prior art this problem has been avoided by using a plastic rectangular waveguide that interconnects two subsystems. The plastic waveguide is attached with one end to one of the subsystems and with the other end to another of the subsystems (e.g. Fukuda et al., “A 12.5+12.5 Gb/s Full-Duplex Plastic Waveguide Interconnect”, IEEE Journal of Solid-State Circuits, Vol. 46, No. 12, pages 3113 to 3125, December 2011). This approach entails using a plurality of individual plastic rectangular waveguides, each waveguide forming an end-to-end link between two modules and one waveguide forming an end-to-end link between the source and the first module. As such, the source signal has two conversions at each module, a conversion from the waveguide to the module and a reconversion from the module to the next waveguide. This type of arrangement has several disadvantages. First, including two interfaces per module, one for conversion and one for reconversion of the source signal, takes up more space on each module and the resulting modules are harder to manufacture. Secondly, as there are two interfaces per module the source signal also loses power twice for each module resulting in the need for a stronger source signal or a shorter waveguide arrangement.

### SUMMARY OF CERTAIN INVENTIVE ASPECTS

It is an object of the disclosed technology to provide a waveguide arrangement which can couple a source signal to a plurality of modules more efficiently.

This object is achieved according to the disclosure with a waveguide arrangement comprising: a continuous waveguide configured to guide a signal provided by the source; and a plurality of interfaces, each interface being associated with one of the plurality of modules and being configured to transfer a part of the source signal guided in the waveguide to its associated module.

The continuous waveguide allows a continuous propagation of the source signal without needing a reconversion at each module. As such, the waveguide arrangement loses less power compared to the prior art as there is no need for reconverting the source signal at each module. Moreover, due to the continuous propagation of the source signal each module receives the exact same input signal which improves the coherence or phase noise correlation between the modules. Furthermore, the modules are smaller as they do not need on-chip oscillators or interfaces to reconvert the signal for transmission back to the waveguide thus saving space on the modules.

In an embodiment of the disclosed technology, each interface comprises: a first layer configured to couple the interface to the waveguide; and a coupler configured to couple the first layer to the module associated with the interface.

The first layer of the interface provides a mechanical connection between the waveguide and the coupler. The coupler design determines how much of the source signal is transferred to the module thus providing a flexible design depending on the relative fraction of the source signal required for transferal to a module.

In an embodiment of the disclosed technology, the first layer is perforated to form a low permittivity medium.

In this way, the first layer is effectively matched to the permittivity of the waveguide and does not substantially disturb the propagation of the source signal in the waveguide.

In an embodiment of the disclosed technology, the coupler of each interface is a direct connection.

This direct connection ensures a minimal power loss of the signal during transition from the first layer to the module which in turn further increases the efficiency of the waveguide arrangement.

In an embodiment of the disclosed technology, the waveguide has a crenelated surface, each crenel comprising a part of the first layer of one interface of the plurality of interfaces.

The crenelated surface ensures that the first layer is partly located inside the waveguide which provides an increased mechanical connection between the waveguide and the coupler.

In an embodiment of the disclosed technology, each interface comprises a second layer configured to form a fixed surface for mounting one of the plurality of modules.

This fixed surface ensures that the entire module remains fixed so that the relevant parts are coupled with the source signal.

In an embodiment of the disclosed technology, the waveguide has a crenelated surface, each crenel comprising a part of an interface of the plurality of interfaces.

The crenelated surface has the same advantages as discussed above but is not limited to a multi-layer interface design which increases the design options depending on the specific structure in which the waveguide arrangement needs to be installed.

In an embodiment of the disclosed technology, the waveguide arrangement further comprises a first end-connector and a second end-connector, the first end-connector being connected to a first end of the waveguide and configured to connect the waveguide to the source, and the second end-connector being connected to a second end of the waveguide and configured to connect the waveguide to one of: a further module and a further waveguide.

By providing a module at the end of the waveguide, no source signal is wasted as the remaining part is directly fed into the module. Furthermore, by providing a connection to a further waveguide the waveguide arrangement may be made as long as needed if the source signal is strong enough. As such, the second end-connector increases the flexibility of the waveguide arrangement.

In an embodiment of the disclosed technology the waveguide is formed by at least one of: a single-layer plastic; a multi-layer plastic; and a non-radiative dielectric guide.

These different materials allow a flexible design of the waveguide arrangement depending on the structure in which the waveguide arrangement needs to be installed.

In an embodiment of the disclosed technology the waveguide has a length between 5 cm and 80 cm between adjacent modules.

In an embodiment of the disclosed technology the waveguide has a length between 10 cm and 60 cm between adjacent modules.

It is another object of the disclosed technology to provide a multi-static radar system comprising a source and a plurality of modules configured to transmit a signal provided by the source and for receiving a signal corresponding to the transmitted signal in which the source signal is coupled to the plurality of modules more efficiently.

This is achieved according to the disclosure with a multi-static radar system in which the plurality of modules are coupled to the source using a waveguide arrangement as discussed above.

This multi-static radar system has the same advantages resulting from the use of the waveguide arrangement as discussed above. Furthermore, by using smaller modules with an easily correlated oscillator signal the angular and depth resolution of the multi-static radar system are improved since more modules can be used in the same space and each of the modules is correlated simultaneously.

In an embodiment of the disclosed technology, the multi-static radar system is a multiple input multiple output (MIMO) radar system.

This offers the added advantages of a MIMO radar system to the advantages already discussed above of the multi-static radar system of the disclosed technology.

It is a further object of the disclosed technology to provide an automotive radar system installed in a vehicle.

This is achieved according to the disclosure with an automotive radar system comprising the multi-static radar system as discussed above.

This automotive radar system has the same advantages as the multi-static radar system discussed above.

It is yet another object of the disclosed technology to provide a kit of parts for constructing the waveguide arrangement as discussed above.

This is achieved according to the disclosure with a kit of parts comprising: the continuous waveguide; the plurality of interfaces; a first end-connector configured to connect the waveguide to a source; and a second end-connector configured to connect the waveguide to one of: a further module and a further waveguide.

It is a further aim of the disclosed technology to provide a method for operating a multi-static radar system comprising a source and a plurality of modules in which the source is coupled to the plurality of modules more efficiently.

This is achieved according to the disclosure with a method comprising: generating a signal in the source; coupling the source signal to the plurality of modules using the waveguide arrangement as discussed above; transmitting the source signal from a transmitter of the plurality of modules; receiving a signal corresponding to the transmitted signal in a receiver of the plurality of modules; and processing the received signal.

This method has the same advantages as the multi-static radar system discussed above.

### BRIEF DESCRIPTION OF THE DRAWINGS

The disclosure will be further explained by means of the following description and the appended Figures.

FIG. 1 shows a waveguide arrangement of the disclosed technology embedded in a bumper of a vehicle.

FIG. 2 shows an individual module of the MIMO radar system of the disclosed technology.

FIG. 3 shows a cross-section through the waveguide arrangement of the disclosed technology focussed near one module.

### DETAILED DESCRIPTION OF CERTAIN ILLUSTRATIVE EMBODIMENTS

The disclosed technology will be described with respect to particular embodiments and with reference to certain drawings but the disclosure is not limited thereto but only by the claims. The drawings described are only schematic and are non-limiting. In the drawings, the size of some of the elements may be exaggerated and not drawn on scale for illustrative purposes.

The disclosed technology relates to a waveguide arrangement, particularly a waveguide arrangement for coupling a plurality of modules to a source. The disclosed technology further relates a multi-static radar system, in particular a multiple input multiple output (MIMO) radar system, in which the modules are coupled to a source by the waveguide arrangement. The disclosed technology further relates to a kit of parts for constructing the waveguide arrangement.

As used herein, the term “MIMO radar system” refers to a radar system comprising a plurality of transmit-receive modules, each module including at least one transmitter configured to transmit a signal and at least one receiver configured to receive a signal corresponding to the transmitted signal, which received signal ideally represents a reflection of the transmitted signal. The received signal is then processed to determine the object and/or the environment where the MIMO radar system is placed.

As used herein, the term “monostatic radar system” refers to a radar system which comprises a transmitter configured to transmit a signal and a receiver configured to receive a signal corresponding to the transmitted signal. The transmitter and the receiver are collocated. Typically, a transmitter and a receiver are referred to as being collocated when the distance between the transmitter antenna and the receiver antenna is up to twice the wavelength of the transmitted signal.

As used herein, the term “bi-static radar system” refers to a radar system which comprises a transmitter configured to transmit a signal and a receiver configured to receive a signal corresponding to the transmitted signal. The transmitter and the receiver are separated by a distance which is related to the expected distance between the bi-static radar system and the target. Typically, a transmitter and a receiver are referred to as forming a bi-static radar system when the distance between the transmitter antenna and the receiver antenna is at least ten times the wavelength of the transmitted signal.

As used herein, the term “multi-static radar system” refers to a radar system including multiple monostatic or bi-static radar subsystems with a shared area of coverage. As such, a multi-static radar system can comprise multiple transmitters with one receiver, i.e. a multiple input single output (MISO) radar system. Further, a multi-static radar system can comprise multiple receivers with one transmitter, i.e. a single input multiple output (SIMO) radar system. When a multi-static radar system comprises both multiple transmitters and multiple receivers it forms a MIMO radar system.

As used herein, the term “module” refers to one of: a transmit-receive module of a MIMO radar system; a transmit-receive module of a monostatic radar system; a transmitter of a bi-static radar system; a receiver of a bi-static radar system; a transmit-receive module of a multi-static radar system; a transmitter of a multi-static radar system; and a receiver of a multi-static radar system. Furthermore, the use of the term “modules” refers to a group comprising at least two modules wherein the modules may be of the same or different type, e.g. the term “modules” may refer a group of two modules comprising a transmit-receive module of a monostatic radar system and a transmitter of a multi-static radar system.

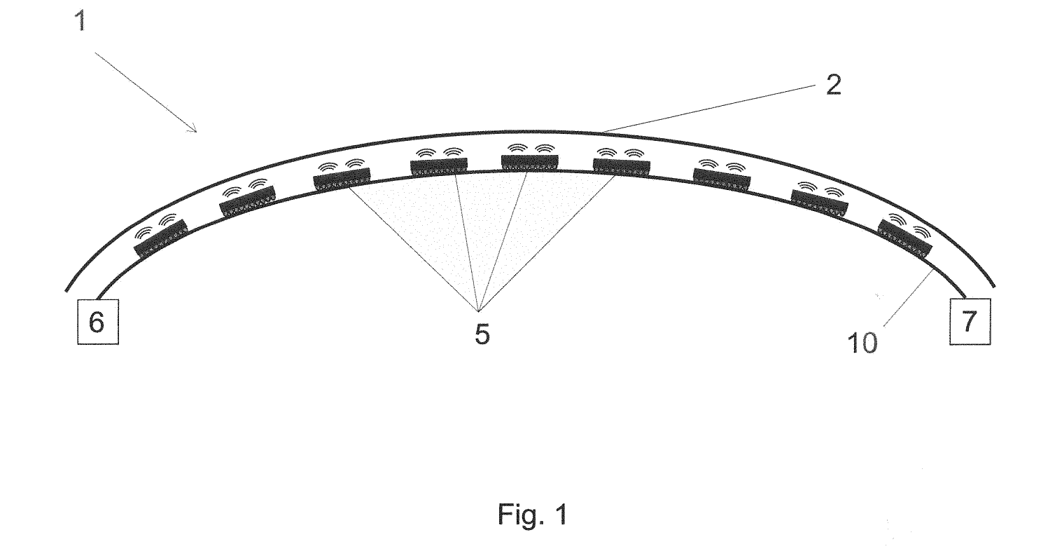

FIG. 1 shows a waveguide arrangement 1 of the disclosed technology embedded in a bumper 2 of a vehicle. It is to be appreciated to one skilled in the art that the MIMO radar system can also be embedded in other regions of a vehicle besides the bumper or simply be attached to the vehicle or can be used as a stationary system which is not embedded in a vehicle. Moreover, it is to be appreciated to one skilled in the art that the waveguide arrangement 1 of the disclosed technology is not limited to a MIMO radar system but can also be used for more general multi-static radar systems.

The waveguide arrangement 1 of the disclosed technology is used for coupling a plurality of modules 5 to a source (not shown). The waveguide arrangement 1 comprises a waveguide 10 configured to guide a signal provided by the source and a plurality of interfaces 15. The source may connected to the waveguide 10 via an end-connector 6 as discussed below. Each of the interfaces 15 is associated with one of the plurality of modules 5 and is configured to couple its associated module 5 to the waveguide 10 by transferring a part of the source signal guided in the waveguide 10 to its associated module 5. As can be seen in FIG. 1 the waveguide 10 is a continuous structure which allows the source signal to propagate continuously without needing reconversion at each module 5. The waveguide arrangement 1 of the disclosed technology thus loses less power compared to the prior art and is thus more efficient.

A further advantage of the waveguide arrangement 1 of the disclosed technology is that the local oscillator represented by the source signal propagates in the same waveform continuously. As such, each module 5 receives the exact same input signal instead of a signal that has been converted and reconverted multiple times during transmission in the waveguide 10 and the modules 5 as is the case in the prior art. Moreover, the modules 5 does not need on-chip oscillators or interfaces to reconvert the signal for transmission back to the waveguide 10, thus saving space on the modules, allowing the modules to be smaller in size. Moreover, smaller modules with an easily synchronized oscillator signal also improve the angular and depth resolution of the MIMO radar system as more modules can be used in the same space and each of the modules is correlated simultaneously.

As each of the interfaces 15 is configured to transfer a part of the source signal to its associated module 5, the signal strength of the source signal in the waveguide 10 decreases with each module 5. Typically, the signal strength decreases as 1/N with N being the total number of modules. The waveguide 10 itself can be formed by different materials. A metal-free structure is possible such as single- or multilayer polyimide or other suitable thin flexible substrates. Alternatively the waveguide 10 can be a non-radiative dielectric guide or an H-guide which are dielectric guides sandwiched between two metal planes.

The choice of waveguide 10 may also depend on the frequency range of the source signal. For frequencies in the range of around 20 GHz to 30 GHz, traditional rectangular metal waveguides provide the most efficient waveguide as they limit the propagation loss. Plastic waveguides are also feasible at these frequencies but need a large cross-section to limit the propagation loss. On the other hand, for frequencies above 100 GHz, plastic waveguides have a lower propagation loss than traditional rectangular metal waveguides without the need for a large cross-section. Depending on the materials used for the waveguides a cross-over point between traditional rectangular metal waveguides and plastic waveguides is around 60 GHz.

As mentioned above, the source signal may be fed into the waveguide 10 at one end of the waveguide 10 by an end-connector 6 which is known in the prior art (e.g. Fukuda et al., “A 12.5+12.5 Gb/s Full-Duplex Plastic Waveguide Interconnect”, IEEE Journal of Solid-State Circuits, Vol. 46, No. 12, pages 3113 to 3125, December 2011). It is to be appreciated for one skilled in the art that other end-connectors between the source and the waveguide 10 are also possible.

Naturally, the waveguide 10 also has a second end with a second end-connector 7. The second end of the waveguide 10 can be connected to a further module using an end-connector 7 as disclosed in the prior art, i.e. an end-to-end end-connector 7 which connects the second end of the waveguide 10 directly to a further module. In this way none of the source signal is wasted as the remaining part is fed directly into a last module. Another option is to couple the second end of the waveguide 10 to a further waveguide using a different type of end-connector 7. As such, the length of the waveguide arrangement 1 is virtually unlimited and depends on the signal strength of the source and the loss by propagation of the source signal as discussed below. A further option is to couple the second end of the waveguide 10 to a processor using an end-connector 7. This processor then receives and processes the received signal of the modules 5. It is to be appreciated for a person skilled in the art that the design of the end-connector 7 may vary depending on the type of connection required at the second end of the waveguide 10 and that the abovementioned possible functions of the second end of the waveguide 10 are not limiting.

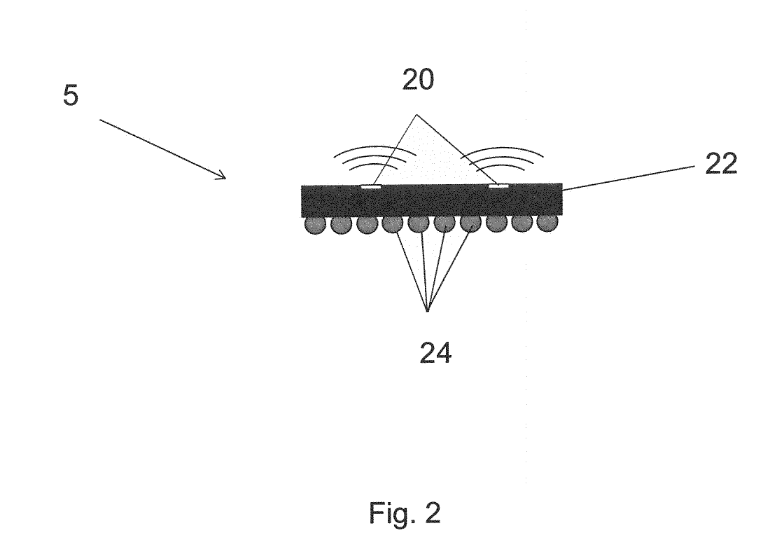

FIG. 2 illustrates an individual module 5 of the MIMO radar system of the disclosed technology. The module 5 includes two transmitters 20 and two receivers (not shown) collocated in a packaged system-on-chip (SOC) 22 with a plurality of connections 24. It is to be appreciated that for one skilled in the art the SOC design may be different and may include different components (e.g. single or multiple transmitters; more or less connections) depending on the type of radar system (e.g. MIMO radar module or monostatic radar module) used.

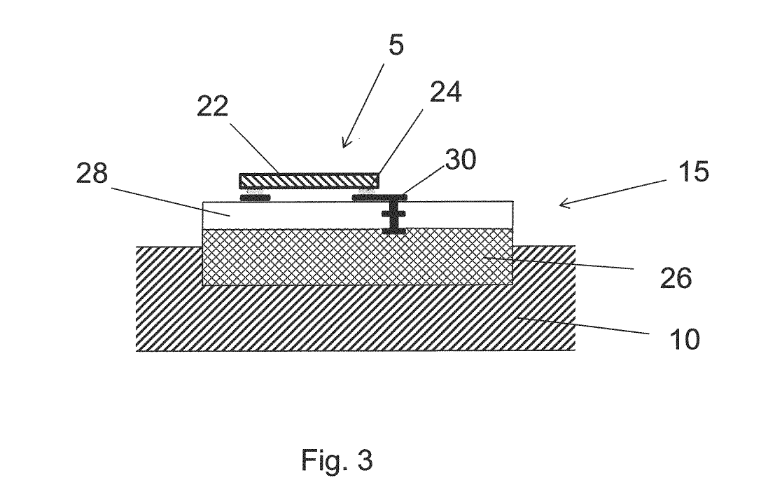

FIG. 3 illustrates a cross-section through the waveguide arrangement 1 of the disclosed technology focussed near one module 5 and illustrates the interface 15 between the waveguide 10 and the module 5. The interface 15 between the waveguide 10 and a module 5 comprises a first layer 26, a second layer 28, and a stack of pads 30.

The first layer 26 is a perforated zone having a low permittivity. This layer acts as a mechanical support for the second layer 28 and the stack of pads 30. Moreover, the low permittivity ensures that the first layer 26 does not substantially disturb the propagation of the source signal in the waveguide 10. In this way, the source signal is substantially unmodified by propagation in the waveguide 10. The second layer 28 determines how much of the source signal is transferred to the module 5. In particular, the stack of pads 30 couples the waveguide 10 to the module 5 by oscillating coherently with the source signal, and, as such, removing a part of the source signal from the waveguide 10. It is this stack of pads 30 that determines how much power of the source signal is taken at each interface 15 and thus correspondingly how many interfaces 15 can be placed on a waveguide 10 with a single source before the source signal is depleted. The relative fraction of the source signal that is transferred from the waveguide 10 via an interface 15 to the module 5 can depend on several factors: the material of the perforated layer 26; the material of the second layer 28; the shape of the stack of pads 30; the relative placement of the perforated layer 26 in the waveguide 10 as discussed below; or the material of the waveguide 10.

Naturally, the source signal also loses power due to propagation in the waveguide 10. The rate of this power loss depends on the waveguide 10 itself, in particular on the materials and structures used to form the waveguide 10. For typical plastic waveguides, this loss is in the range of 2 to 3 dB/m for source signals having frequencies around 60 GHz to 70 GHz. Depending on the loss by propagation, the distance between adjacent modules 5 may change. In general, a distance in a range between 5 cm and 80 cm, and, preferably, in a range between 10 cm and 60 cm, between adjacent modules 5 is possible for a radar system embedded in a car bumper. However, this spacing may also be lower than 5 cm depending on the materials used and the size of the modules.

As can be seen from FIG. 3, the bottom part of the perforated layer 26 is placed in a crenel (not referenced in the Figures for the sake of clarity) of the waveguide 10. As used herein, the term “crenel” refers to a position in the waveguide 10 provided for placing an interface 15. In particular, the crenel is a hole in the waveguide 10 and can have different shapes, such as substantially rectangular, circular, triangular, etc. with the interface 15 having a corresponding shape. Since the waveguide 10 couples a plurality of modules 5 it also has a corresponding plurality of crenels. In other words, the waveguide 10 has a crenelated surface and is continuous below the crenelated surface. As such, in the context of the disclosed technology, the waveguide is continuous indicates that a signal may propagate continuously in the waveguide 10 even though a part of the waveguide 10 has crenels provided for the interfaces 15.

As can be seen in FIG. 3, the top part of the perforated layer 26 projects above the waveguide 10. It is to be appreciated for one skilled in the art that this is not essential for the disclosed technology. The perforated layer 26 can also be located entirely within the waveguide 10 or have a bottom surface corresponding to the top surface of the waveguide 10. In other words, the perforated layer 26 may be located entirely outside the waveguide 10. The relative placement of the perforated layer 26 with respect to the waveguide 10 and also its thickness relative to the thickness of the waveguide 10 is designed according to the fraction of the source signal power that needs to be transferred to the module 5. As illustrated in FIG. 3, the bottom 70% of the perforated layer 26 is located within the waveguide 10. For example, if this would only be the bottom 10% the stack of pads 30 may be located further away from the waveguide 10 which could result in there being a larger loss as the source signal needs to propagate over a larger distance.

The second layer 28 forms a fixed surface which is used as a mounting surface for the module 5. This second layer 28 needs to be fixed to ensure that the entire module 5 is fixed and that the relevant parts are coupled with the source signal.

As can be seen in FIG. 3, the stack of pads 30 makes contact with respective ones of connection 24 of the module 5 and couples the module 5 to the perforated layer 26 through the fixed layer 28. This stack of pads 30 forms the connection through which a part of the source signal is transferred from the perforated layer 26 to the SOC 22 via connection 24. It is to be appreciated for one skilled in the art that this stack of pads 30 can also have a different shape or size as long as it forms a connection that enables transferring the signal from the perforated layer 26 to the connection 24 of the module 5. This connection can also be an indirect connection depending on the design of the interface 15.

It is to be appreciated for one skilled in the art that while the interface 15 has been described in reference to a single module 5, interfaces 15 coupling the other modules 5 to the waveguide 10 may have a similar or identical structure. Moreover, it is to be appreciated that while FIG. 3 shows the interface 15 and the module 5 on the top side of the waveguide 10, this is only illustrative. The interface 15 and the module 5 can have a different relative orientation, e.g. the interface 15 can also be placed on the bottom or on a side of the waveguide 10.

The waveguide arrangement 1 discussed above can be used to control a radar system (e.g. a multi-static radar system). This radar system can be a stand-alone system or be embedded in a vehicle, for example. The waveguide arrangement 1 is used for making each of the modules 5 of the radar system use the same source signal representing a local oscillator of the modules 5 according to the following method.

A source signal is first generated in a source and is coupled to a first end of the waveguide 10 using a first end-connector 6. As stated above such an end-connector 6 is already known in the prior art. Because the waveguide 10 is continuous, the source signal propagates through the entire waveguide 10 without having transitions between different waveforms (e.g. a planar waveform to a rectangular waveform). Each interface 15 in the waveguide 10 transfers a part of the source signal that propagates in the waveguide 10 to the module 5 associated with the interface 15. In response to the source signal each of the modules 5 can then transmit a signal coherently with the other modules 5. The transmitted signals interfere with one another and with objects in the surveyed scene, in particular the transmitted signals are reflected and/or refracted by these objects. The next step is to receive a signal by the one or more receivers present in the plurality of modules 5. This received signal represents the surveyed scene and can be used to determine properties about the scene. The received signals are processed on the modules themselves and a digital representation of the baseband signal is transferred as an output of each module via well-known BUS interfaces on the modules. Alternatively, the received signals can also be processed in a separate processor. For example, this can be achieved by using an end-connector 7 on the second end of the waveguide 10 as a link to a separate processor. It is to be appreciated for one skilled in the art that processing the received signals can also be performed in various other manners.

The waveguide arrangement 1 discussed above can be constructed from a kit of parts comprising: the continuous waveguide 10; the plurality of interfaces, the first end-connector 6 configured to connect the waveguide 10 to a source, and the second end-connector 7 configured to connect the waveguide 10 to one of: a further module and a further waveguide. The individual parts have been discussed above. This kit of parts allows a flexible design of the waveguide arrangement 1. For example, depending on the needs of a specific radar system, both the number of interfaces 15 and the length of the waveguide 10 may be customized.

Although aspects of the disclosed technology have been described with respect to specific embodiments, it will be readily appreciated that these aspects may be implemented in other forms.

What is claimed is:

1. A waveguide arrangement for coupling a plurality of modules to a source, the waveguide arrangement comprising:
a continuous waveguide configured to guide a signal provided by the source; and
a plurality of interfaces, each interface being associated with one of the plurality of modules and being configured to transfer a part of the source signal guided in the waveguide to its associated module.

2. The waveguide arrangement according to claim 1, wherein each interface comprises:
a first layer configured to couple the interface to the waveguide; and
a coupler configured to couple the first layer to the module associated with the interface.

3. The waveguide arrangement according to claim 2, wherein the first layer is perforated to form a low permittivity medium.

4. The waveguide arrangement according to claim 2, wherein the coupler of each interface is a direct connection.

5. The waveguide arrangement according to claim 2, wherein the waveguide has a crenelated surface, each crenel being formed as a part of the first layer of one interface of the plurality of interfaces.

6. The waveguide arrangement according to claim 2, wherein each interface comprises a second layer configured to form a fixed surface for mounting one of the plurality of modules.

7. The waveguide arrangement according to claim 1, wherein the waveguide has a crenelated surface, each crenel being formed as a part of an interface of the plurality of interfaces.

8. The waveguide arrangement according to claim 1, wherein the waveguide arrangement further comprises a first end-connector and a second end-connector, the first end-connector being connected to a first end of the waveguide and configured to connect the waveguide to the source, and the second end-connector being connected to a second end of the waveguide and configured to connect the waveguide to a further module and/or a further waveguide.

9. The waveguide arrangement according to claim 1, wherein the waveguide is formed from at least one of the following: a single-layer plastic, a multi-layer plastic, and a non-radiative dielectric guide.

10. The waveguide arrangement according to claim 1, wherein the waveguide has a length between 5 cm and 80 cm between adjacent modules.

11. The waveguide arrangement according to claim 1, wherein the waveguide has a length between 10 cm and 60 cm between adjacent modules.

12. A multi-static radar system comprising a source and a plurality of modules configured to transmit a signal provided by the source and for receiving a signal corresponding to the transmitted signal, wherein the plurality of modules is coupled to the source using a waveguide arrangement according to claim 1.

13. The multi-static radar system according to claim 12, wherein the multi-static radar system is a multiple input multiple output radar system.

14. An automotive radar system installed in a vehicle, wherein the automotive radar system comprises the multi-static radar system according to claim 12.

15. A kit of parts for constructing the waveguide arrangement according to claim 1, the kit comprising:
the continuous waveguide;
the plurality of interfaces;
a first end-connector configured to connect the waveguide to a source; and
a second end-connector configured to connect the waveguide to a further module and/or a further waveguide.

16. A method of operating a multi-static radar system comprising a source and a plurality of modules, the method comprising:
generating a signal in the source;
coupling the source signal to the plurality of modules using the waveguide arrangement according to claim 1;
transmitting the source signal from a transmitter of the plurality of modules;
receiving a signal corresponding to the transmitted signal in a receiver of the plurality of modules; and
processing the received signal.

17. The waveguide arrangement according to claim 3, wherein the coupler of each interface is a direct connection.

18. The waveguide arrangement according to claim 3, wherein the waveguide has a crenelated surface, each crenel being formed as a part of the first layer of one interface of the plurality of interfaces.

19. The waveguide arrangement according to claim 4, wherein the waveguide has a crenelated surface, each crenel being formed as a part of the first layer of one interface of the plurality of interfaces.

20. The waveguide arrangement according to claim 3, wherein each interface comprises a second layer configured to form a fixed surface for mounting one of the plurality of modules.
